(19) United States
(12) Patent Application Publication
(10) Pub. No.: US 2008/0308180 A1
(43) Pub. Date: Dec. 18, 2008

(54) Sealing system for fill pipe head, associated pipe and tank

(75) Inventors: Patrice Baudoux, FLAVY LE MARTEL (FR); Frederic Jannot, Bousval (BE)

Correspondence Address: OBLON, SPIVAK, MCCLELLAND MAIER & NEUSTADT, P.C., 1940 DUKE STREET, ALEXANDRIA, VA, 22314, US

(73) Assignee: INERGY AUTO. SYSTEMS RESEARCH (SOCIETE ANONYME), Brussels (BE)

(21) Appl. No.: 12/213,144

(22) Filed: Jun. 16, 2008

(30) Foreign Application Priority Data
Jun. 14, 2007 (FR) 0755751

(51) Int. Cl. B60K 15/05

(52) U.S. Cl. 141/349; 220/262; 220/86.2

(57) ABSTRACT

Sealing system for fuel tank fill head comprising:
a valve that can be moved between an open position, in which fuel may be introduced into a fill pipe, and a closed position in which the fill pipe is closed, the valve passing from one position to the other under the effect of a pressure exerted by a filling nozzle head;
a locking system capable of locking the valve in its closed position; and
an actuation system capable of being moved between a closed position and an open position under the effect of introducing the filling nozzle into the fill head.

The locking system and the actuation system are capable of cooperating together so that a displacement of the actuation system from its closed position to its open position causes a displacement of the locking system from a locked position to an unlocked position.

The actuation system comprises a rotatable cam equipped with a coupling pin capable of cooperating with the locking system.

The invention also relates to a fill pipe equipped with such a sealing system and to a fuel tank equipped with such a fill pipe.

The present invention relates to a sealing system for a pipe for filling a fuel tank having a locking system capable of being activated by the introduction of a fuel nozzle.

The fill pipes present in fuel tanks, in particular the tanks aboard motor vehicles, are sealed during normal use of the tank, when not being filled. The sealing is generally achieved either by means of a cap or by means of a sealing system integrated into the fill pipe, often called a “capless” system.

Improved versions of capless systems generally comprise a valve and a protective shield. Thanks to the protective shield the valve is protected and inaccessible. In order to allow access to the fill pipe when filling the tank, the user uses a filling nozzle and brings it into contact with the shield so as to move it to an open position allowing access to the valve and therefore the filling of the tank itself.

It is also known to equip the sealing system with a locking system capable of keeping the valve in a closed position so that, when not being filled, the fill pipe is sealed against fuel losses and so that access to the inside of the pipe is only possible when the locking system has been forced into an unlocked position.

It is known to actuate the locking system from a movement of a fuel filler flap. Said flap is in general capable of being moved between a closed position in which it protects the access to the fill pipe and an open position where the access to the pipe is rendered possible and therefore allows the introduction of the filling nozzle.

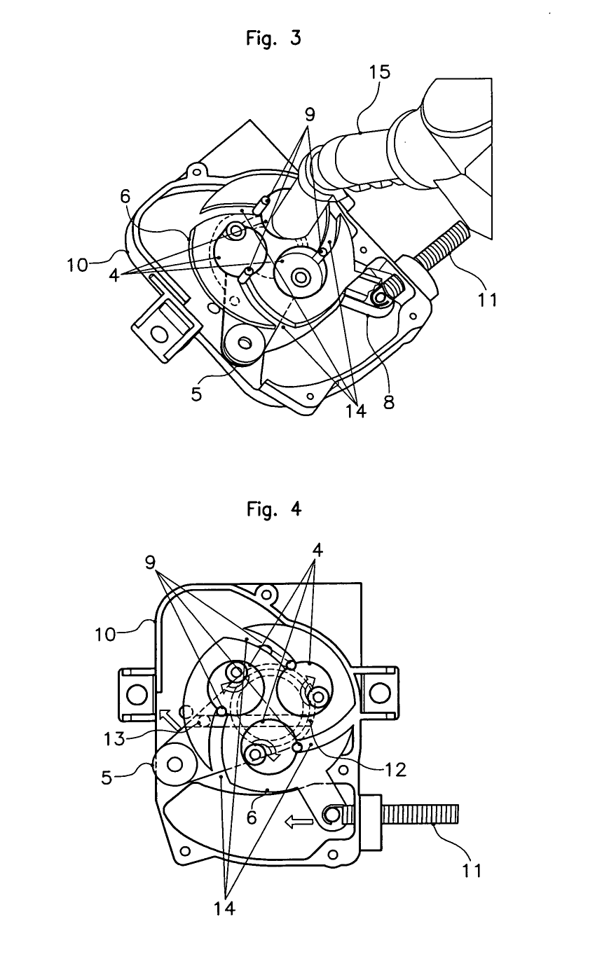

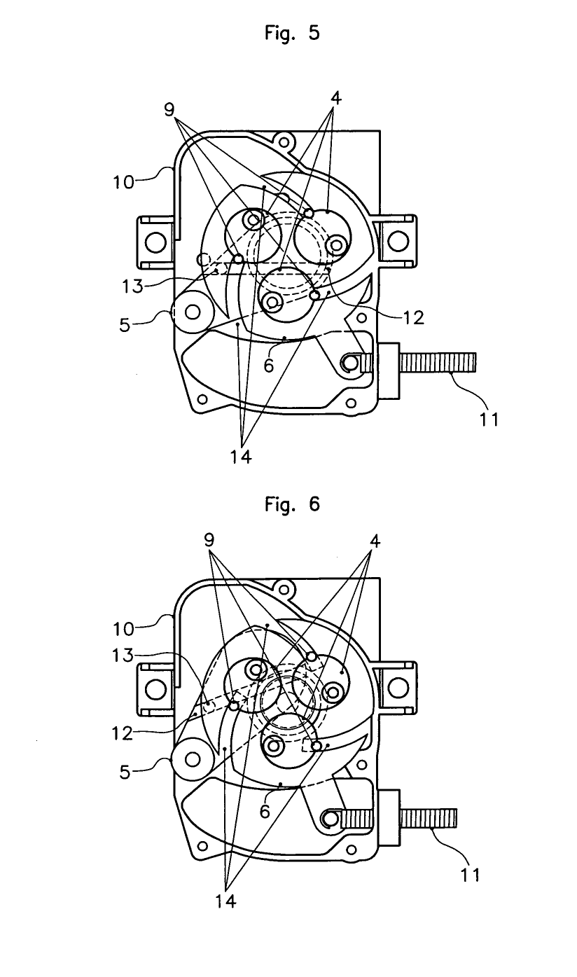

Patent EP 0 872 371 describes such a system in which a fuel filler flap is mechanically connected, via a rod linkage device to a valve locking system. FIGS. 2 and 3 from Patent EP '371 represent the closed position of the flap and the locked position of the valve whilst FIGS. 4 and 5 represent the open position of the flap and the unlocked position of the locking system.

Such a system has the disadvantage that rupture of the mechanical connection between the flap and the locking system leads to a blockage of the system. Moreover, when the flap is in the open position, the locking system is in an unlocked position which allows access to the valve. In the case where a user cleans the space delimited by the flap in the closed position and the pipe head—a space generally referred to as the “filling bowl”—with a jet of pressurized water, he is capable of introducing liquid into the fill pipe.

The object of the invention is to overcome the disadvantages of the known systems and to provide a sealing system equipped with a locking system that can be moved between a locked position and an unlocked position independently of the position of the flap.

The sealing system according to the invention is also of reduced size.

For this purpose, the invention relates to a sealing system for a fuel tank fill head comprising:
a valve that can be moved between an open position, in which fuel may be introduced into a fill pipe, and a closed position in which the fill pipe is closed, the valve passing from one position to the other under the effect of a pressure exerted by a filling nozzle head;
a locking system capable of locking the valve in its closed position; and
an actuation system capable of being moved between a closed position and an open position under the effect of introducing the filling nozzle into the fill head;
   the locking system and the actuation system being capable of cooperating together so that a displacement of the actuation system from its closed position to its open position causes a displacement of the locking system from its locked position to its unlocked position,
   characterized in that the actuation system comprises a rotatable cam equipped with a coupling pin capable of cooperating with the locking system.

The valve makes it possible to close the fill pipe of the fuel tank. In a “capless” type system, the valve takes the place of the conventional closure cap screwed onto the pipe head by the user. In such a system, a seal is generally located between the valve and the pipe head, or more accurately around the perimeter of the opening in this pipe head that the valve aims to seal, so as to enable leaktight closure of the head of the fuel tank fill pipe, thus avoiding contamination of the atmosphere by liquid or gaseous fuel. This seal may be of any type. An O-ring seal gives good results. The constituent material of this seal will preferably be chosen so as to tolerate fuel vapours. Fluorinated elastomers are suitable for this purpose.

The expression “fuel tank” is understood to mean any type of tank able to store a liquid and/or gaseous fuel under varied pressure and temperature conditions. Those more particularly targeted are tanks of the kind found in motor vehicles. The expression “motor vehicle” is intended to include motor cars, motorcycles and trucks.

The fill pipe is a pipe which communicates with the inside of the tank and allows fuel to be introduced into it.

The tank and the pipe may be made of metal or of plastic.

The sealing system according to the invention is very suitable for a tank and fill pipe assembly in which at least one of the two components of the assembly is made of plastic. It is particularly suitable for an assembly in which the fill pipe is made of plastic. As a preference, this sealing system itself comprises at least one part made of plastic. As a strong preference, it is mainly made of plastic.

The term “plastic” is understood to mean any material comprising at least one synthetic polymer resin.

Any type of plastic may be suitable. Particularly suitable plastics belong to the category of thermoplastics.

The term “thermoplastic” is understood to mean any thermoplastic polymer, including thermoplastic elastomers, and also blends thereof. The term “polymer” is understood to mean both homopolymers and copolymers (especially binary or ternary copolymers). Examples of such copolymers are, non-limitingly: random copolymers, linear block copolymers, other block copolymers and graft copolymers.

Any type of thermoplastic polymer or copolymer, the melting point of which is below the decomposition temperature, is suitable. Synthetic thermoplastics having a melting range spread over at least 10 degrees Celsius are particularly suitable. Examples of such materials include those that exhibit polydispersion in their molecular weight.

In particular, it is possible to use polyolefins, polyvinyl halides, thermoplastic polyesters, polyketones, polyamides and copolymers thereof. A blend of polymers or copolymers may also be used, similarly it is also possible to use a blend of polymeric materials with inorganic, organic and/or natural fillers such as, for example but non-limitingly: carbon, salts and other inorganic derivatives, natural or polymeric fibres. In particular, fibre-filled (for example glass-fibre-filled) polyamides are particularly suitable. Advantageously, at least some of these polymeric materials contain a conductive filler (carbon black, for example) in order to avoid problems associated with static electricity. It is also possible to use multilayer structures composed of stacked and joined layers comprising at least one of the polymers or copolymers described above.

The sealing system that the invention aims to lock has the role of acting as a cap which seals the upper part of the fill pipe when the tank is not being filled, with a view to avoiding any release and loss of liquid fuel and vapour into the atmosphere when the tank contains fuel.

This sealing system according to the invention is built into the fill pipe head, that is to say is incorporated into a set of parts which are mounted on the upper end of the fill pipe and the purpose of which is to guide a fuel pump nozzle and make filling easier. To do this, the pipe head comprises an opening that communicates with (is in the extension of) the fill pipe and that the valve of the system according to the invention makes it possible to seal, in a leaktight manner, when in the closed (locked) position. This fill opening generally emerges into a filling bowl (or concave indentation in the body of the vehicle and which is generally sealed by a flap known as a fuel filler flap). The pump nozzle is the nozzle fitted to the flexible fuel pump hoses in service stations. The sealing system comprises a valve, that is to say a device that prevents the passage of gases and liquids through the aforementioned opening in the pipe head. This valve may be in various forms. One form that is particularly suitable is the form of a moving plate which blocks the passage when in the closed position. As a preference, this plate pivots about an axis. It is advantageously made of plastic but is preferably equipped with a metal cover, particularly for aesthetic reasons and for resistance to abrasion (wear following numerous insertions of filling nozzles).

According to the invention, the sealing system comprises a locking system. The locking system is capable of occupying, in general, an unlocked position in which the valve can be moved and a locked position in which the valve is locked in its closed position.

Preferably, the locking system comprises a ring which forms part of a bayonet-type system. The ring (which preferably is substantially in the shape of a hoop) can generally be rotated about a bayonet system for which the cooperating parts (reliefs) are preferably positioned, respectively, on an inner surface (or most particularly preferably: around the perimeter of an internal opening) of the ring and around the outer perimeter of the valve. These reliefs preferably have a geometry which allows not only a rotational movement of the ring between the locked position and the unlocked position of the bayonet, but also a “vertical” movement (parallel to the axis of the valve) of this ring to respectively compress/decompress the seal located between the valve and the top of the pipe.

Thus, for example, one part (the ring, for example) may comprise recesses suitable in number, size and shape to permit the movement and passage of lugs positioned on the other part (the valve). In particular, the recesses in the ring (or in the valve) advantageously include a ramp and notches corresponding in number, size and shape to the number of lugs positioned on the valve (or on the ring). Most particularly preferably, the ramp and lugs are bevelled in a complementary manner, i.e. have a discontinuous relief capable of facilitating their movement, which is both vertical and rotary.

In such systems, in the locked position of the ring, the recesses are engaged over a “horizontal” part (perpendicular to the axis of the valve and of the ring) of the ramp and block the valve (a thrust along the axis does not enable it to be displaced).

More preferably, the bayonet ring is firmly attached to a return spring so that the ring is prestressed in its locked position.

The sealing system according to the invention also comprises an actuation system capable of controlling the operation of the locking system (i.e. controlling a displacement of the locking system from a locked position to an unlocked position) and which may be actuated specifically under the effect of introducing the filling nozzle into the fill head.

The actuation system comprises a rotatable cam equipped with a coupling pin capable of cooperating with the locking system to displace this locking system from its locked position to its unlocked position when the cam is rotated.

Preferably, the actuation system additionally comprises at least one and preferably three rotatable components capable of cooperating with the moveable cam and capable of being displaced under the effect of introducing the nozzle into the fill head.

More preferably, the moveable components each have at least one spherical surface portion capable of coming into contact with the filling nozzle head. These may be, for example, moveable balls that are generally capable of being rotated about an axis of rotation substantially parallel to the longitudinal axis of the fill head.

In particular, the sealing system comprises a protective shield that is positioned upstream of the valve and makes it possible to protect the seal and the mechanics around the valve from dust or any other contamination, thus ensuring the proper operation of the valve. The shield can be moved between an open position in which the valve is accessible and a closed position in which the valve is protected from the atmosphere by the shield. Within the context of the invention, the shield generally comprises a plate that can be rotated about an axis substantially parallel to the longitudinal axis of the fill head.

Within the context of the invention, it is understood to define that a first component is upstream of a second component when the first component is above the second component relative to the direction for introducing the filling nozzle into the fill pipe.

Preferably, the shield is prestressed in its open position by elastic return means.

In one particular embodiment of the system according to the invention, the cam of the sealing system is equipped with a drive pin that is capable of cooperating with the shield so that the shield is displaced from its closed position to its open position when the cam is rotated under the effect of introducing the filling nozzle into the fill head.

In a second particular embodiment, the bayonet ring of the locking system is equipped with a drive pin that is capable of cooperating with the shield so that the shield is displaced from its closed position to its open position when the bayonet ring is rotated under the effect of introducing the filling nozzle into the fill head.

Preferably, the cam comprises guides intended to cooperate with the lugs of the moveable components. As explained above, the moveable components are capable of cooperating with the cam which can be driven by the moveable components when these are displaced under the effect of the pressure exerted by the introduction of a filling nozzle head. The guides generally consist of reliefs made in the cam that have a profile so that when the moveable components are rotated, the lugs of the moveable components cooperate with the guides of the cam so as to exert a force on these and therefore displace the cam. The invention also aims to cover a fill pipe for a fuel tank equipped with a sealing system such as described above, and also a fuel tank equipped with such a pipe.

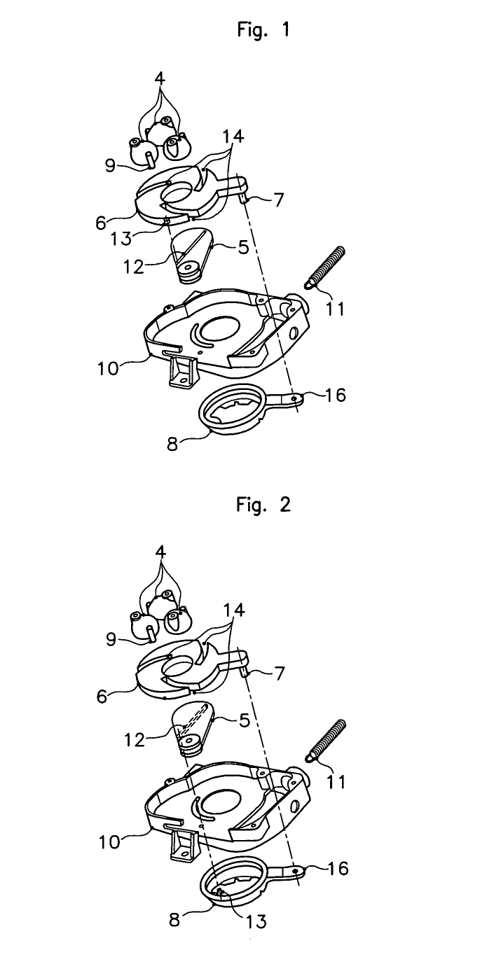

### DESCRIPTION WITH THE AID OF FIGS. 1 TO 7

Other particular aspects and features of the invention will become apparent from the description of a few advantageous embodiments presented below, by way of illustration, with reference to the appended drawings which show:

FIGS. 1 & 2: exploded bottom views for 2 variants of a sealing system according to the invention;

FIG. 3: overview of a system according to the invention during the introduction of a filling nozzle;

FIG. 4: overview of a system according to the invention with indication of the directions of movement of the parts during the introduction of a filling nozzle; and

FIGS. 5 to 7: overviews for 3 positions of the sealing system (locked, intermediate and open, respectively).

FIG. 1 illustrates a 1^{st} variant of a system according to the invention that comprises a valve (not represented), balls (4) each equipped with a lug (9) and a cam (6). The balls (4) are rotated about an axis substantially parallel to the longitudinal axis of the fill head under the effect of introducing a filling nozzle. The cam (6) has 3 guides (14) which cooperate with the lugs (9) so that a displacement of the balls (4) leads to a displacement of the lugs (9) and to a rotation of the cam (6). According to this variant, the cam (6) is equipped with a drive pin (13) that cooperates with a groove (12) positioned on a shield (5) so that when the cam (6) is rotated, the shield (5) is displaced from a closed position to an open position or from an open position to a closed position depending on whether the cam (6) is displaced from a position corresponding to closure of the sealing system towards a position corresponding to an open position of said system or vice versa. Also according to this variant, the assembly formed by the balls (4), the cam (6) and the shield (5) is mounted on a support (10). The system according to this variant also comprises a bayonet-type ring (or more specifically: a closure system comprising a ring (8) equipped with notches intended to cooperate with lugs on the valve according to a bayonet mechanism) equipped with a drive strap (16). The cam (6) is equipped with a coupling pin (7) capable of cooperating with an orifice positioned on the drive strap (16) so that when the cam (6) is rotated, the pin (7) also rotates the ring (8).

According to the 2^{nd} variant illustrated in FIG. 2, the shield (5) is not driven by a movement of the cam (6). This is because the ring (8) is equipped with a drive pin (13) that cooperates with a groove (12) positioned on a shield (5) so that it is a movement of the ring (8) which is capable of driving a movement of the shield (5) when the balls (4) are rotated under the effect of introducing the filling nozzle.

According to the two variants illustrated in FIGS. 1 and 2, the ring (8) is prestressed in a locked position of the valve under the effect of a spring (11).

Represented in FIG. 3 is an overview of a system according to the 1^{st} variant of the invention where a filling nozzle (15) has been brought nearer to the sealing system so as to be introduced into the fill head.

Represented by arrows in FIG. 4 are the rotational directions of the moveable parts of a system according to the invention when the filling nozzle is introduced into the fill head. The balls (4) can be rotated about an axis substantially parallel to the longitudinal axis of the fill head and are displaced under the effect of a contact force from the filling nozzle. When the balls (4) are displaced, the lugs (9) drive the cam (6) via the guides (14). According to the variant illustrated in FIG. 4, the drive pin (13) of the cam (6) cooperates with the shield (5) so that a displacement of the cam (6) drives a displacement of the shield (5).

FIGS. 5 to 7 illustrate for 3 positions of the sealing system from FIGS. 3 and 4.

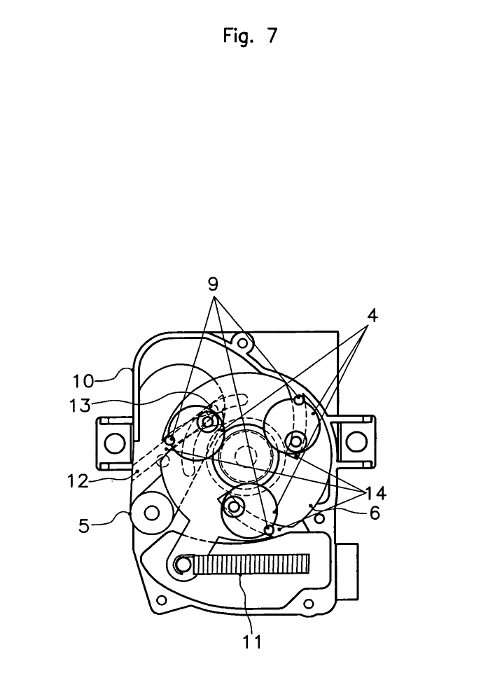

FIG. 5 corresponds to a locked position of the system in which the shield (5) is in the closed position and the valve (not represented) is also in a closed position and is locked in this position by the ring (8) (not represented), whereas FIGS. 6 and 7 correspond respectively to a position of intermediate opening of the system and a position of complete opening of the system.

In the intermediate position illustrated in FIG. 6, under the effect of introducing the filling nozzle, the balls (4) are rotated and the lugs (9), in their movement, drive the cam (6). The drive pin (13) is displaced with the cam (6) and it cooperates with the groove (12) so that the shield (5) is also displaced to an intermediate position.

In the position illustrated in FIG. 7, the balls (4) are in a position corresponding to the introduction of the filling nozzle into the fill pipe head. The cam (6) is in a position corresponding to the displacement of the lugs (9) and the shield (5) is in a completely open position resulting from the displacement of the drive pin (13) in the groove (12).

1. Sealing system for fuel tank fill head comprising:
a valve that can be moved between an open position, in which fuel may be introduced into a fill pipe, and a closed position in which the fill pipe is closed, the valve passing from one position to the other under the effect of a pressure exerted by a filling nozzle head;
a locking system capable of locking the valve in its closed position; and
an actuation system capable of being moved between a closed position and an open position under the effect of introducing the filling nozzle into the fill head;
the locking system and the actuation system being capable of cooperating together so that a displacement of the actuation system from its closed position to its open position causes a displacement of the locking system from its locked position to its unlocked position,
characterized in that the actuation system comprises a rotatable cam equipped with a coupling pin capable of cooperating with the locking system.

2. Sealing system according to the preceding claim, characterized in that the locking system comprises a bayonet-type ring.

3. Sealing system according to the preceding claim, characterized in that the ring is firmly attached to a return spring so that the ring is prestressed in its locked position.

4. Sealing system according to any one of the preceding claims, characterized in that it additionally comprises at least 3 rotatable components capable of cooperating with the cam.

5. Sealing system according to any one of the preceding claims, characterized in that it additionally comprises a shield placed upstream of the valve and that can be moved between an open position in which the valve is accessible and a closed position in which the valve is protected from the atmosphere by the shield.

6. Sealing system according to the preceding claim, characterized in that the shield is prestressed in its open position by elastic return means.

7. Sealing system according to either one of claims 5 and 6, characterized in that the cam is equipped with a drive pin that is capable of cooperating with the shield.

8. Sealing system according to either one of claims 5 and 6, characterized in that the ring is equipped with a drive pin that is capable of cooperating with the shield.

9. Fill pipe for a fuel tank equipped with a sealing system according to any one of the preceding claims.

10. Fuel tank equipped with a fill pipe according to the preceding claim.
